(19) United States
(12) Patent Application Publication
(10) Pub. No.: US 2017/0193723 A1
(43) Pub. Date: Jul. 6, 2017

(54) Door-Lock Using Iris Recognition and System Thereof, Mobile Communication Terminal and Network Gateway Used Therein, And User Authentication Method

(71) Applicant: KT&C Co., Ltd., Seoul (KR)

(72) Inventor: Keun Park, Seoul (KR)

(21) Appl. No.: 15/325,079

(22) PCT Filed: Jun. 10, 2015
(86) PCT No.: PCT/KR2015/005849

§ 371 Date: Jan. 9, 2017

(30) Foreign Application Priority Data
Jul. 9, 2014 (KR) 10-2014-0086233
May 27, 2015 (KR) 10-2015-0074037

(51) Int. Cl. G07C 9/00; E05B 49/00; G06K 9/00; E05B 47/00

(52) U.S. Cl. CPC G07C 9/00563; E05B 47/00; E05B 49/00; G06K 9/00617; G06K 9/00604; G06K 9/00255; G06K 9/0061

(57) ABSTRACT

Disclosed are a door-lock using the iris recognition and an user authentication method. The door-lock comprises; a wake-up module for recognizing user access or driving the door-lock according to the user button input; and an iris recognition module for comparing an iris pattern inputted to said door-lock with a pre-stored iris pattern, and authenticating the user approaching said door-lock based on the comparison result after the door-lock is driven.

### CROSS-REFERENCE TO RELATED APPLICATION

This Application is a National Stage Patent Application filed Under 35 U.S.C. §371 of International Patent Application No. PCT/KR2015/005849, filed Jun. 10, 2015, the contents of which are hereby incorporated by reference in their entirety.

### BACKGROUND OF THE INVENTION

Field of the Invention

The present invention relates to a door-lock and authentication method thereof, more particularly, a door-lock using iris recognition and system thereof, a mobile communication terminal and network gateway used therein, and an user authentication method.

Description of Related Art

The security system using a conventional password key and face recognition has been applied for the various types of security alarm systems, safe box, gate, personal computer and ATM (Automatic Teller Machine). However, there have been the security problems due to the leakage of password key. For example, under the operation of ten key pad for inputting the password key, the security risk may be incurred by the input trace left in the ten key pad and the exposure of input.

The recognition performance of the security system using face recognition may be deteriorated as the password key may be wrongly input to the biometric system due to the change in the face recognition information with time. Also, the accessories such as eye glasses, mask, sun glass that cover the face may increase the error in the face recognition.

Accordingly, the technology for the door-lock and user authentication thereof is required to ensure the high security level under the leakage risk of password key and the possibility of change in the biometric information.

Furthermore, beyond the security system restricted to the door-lock itself, the security system using the face recognition is required to allow the home owner in the remote site to identify the visitor's face and automatically open or close the home front door.

### BRIEF SUMMARY OF THE INVENTION

Accordingly, the present invention has been made to solve the aforementioned problems occurring in the related art, and it is an object of the present invention to provide a solution to sense the eye position of user approaching the door-lock and obtain the iris picture through the iris camera, and then to authenticate the user by comparing the iris pattern. Moreover, the degradation of recognition performance due to the change in the biometric information can be prevented by obtaining the user iris pattern through the iris camera with tilt mechanism applied.

The communication module is optionally provided for the communication with mobile device, which improves the user convenience by registering the biometric information from the mobile device into the security system.

Also, the user convenience can be improved by allowing the user in the remote site far away from the home to identify the visitor's face and automatically open or close the home front door.

### Technical Solution

To achieve the above and other objectives, in accordance with an embodiment of the present invention, there is provided the door-lock comprising a wake-up module to recognize the user approach and drive said door-lock by the user's button input, and an iris recognition module to authenticate the user by comparing the iris pattern with the pre-registered pattern once the door-lock is driven by the wake-up module.

The iris recognition module comprises a face photographing means to take the face picture of the user approaching the door-lock, an eye position sensing means to sense the eye position of the user from the picture taken by the face photographing means, a servo control means to control the slope of the face photographing means based on the sensing result of the eye position and generate the control signal for the iris photographing, an iris photographing means to take the iris photograph based on the control signal, and a comparing means to compare the photographed iris with the pre-registered iris pattern, which thus authenticates the user approaching said door-lock.

The iris photographing means is controlled by the tilt mechanism based on said control signal obtained by the servo control means, and slanted according to said eye position.

The wake-up module comprises at least one of approach recognition sensors sensing the body approaching the door-lock, and an input means taking the use's button input, which thus drives the door-lock based on the sensing result and the input signal.

The security system according to the embodiment of the present invention further comprises a mobile device that takes the biometric information including the user's iris; and a door-lock that receives and stores the biometric information from the mobile device, compares the stored biometric information with the biometric information inputted by the user, and authenticates the user based on the comparison result.

The biometric information is the characteristic identification information including iris pattern information, finger print information, retina information, and facial information.

The user authentication method according to the embodiment of the present invention comprises a step of sensing the user approach, a step of taking said user's face picture when the door-lock is driven based on the sensing result, a step of sensing the eye position from the user's face picture, a step of taking the iris picture of the user by the iris camera based on the sensed eye position, and a step of comparing the iris pattern taken by the iris picture with the pre-registered iris pattern and authenticating the user based on the comparison result.

The step of taking the iris picture of the user is done by controlling the slope or motion of the iris camera by the servo control.

The step of taking the iris picture of the user further comprises a step of taking the iris picture by the iris camera and a step of extracting the iris pattern from the iris picture taken.

The pre-registered iris pattern is the data base either of the iris pattern extracted from the iris picture received from the mobile device or of the iris pattern extracted from the iris picture taken by the door-lock.

The door-lock system according to the embodiment of the present invention to achieve the above objective takes the visitor's face picture and sends it to the mobile terminal of the user, which displays the visitor's face picture, and controls the opening motion of the door-lock based on the control signal inputted from the user.

The specific configuration comprises a digital door-lock, a mobile terminal, a network gateway that registers the mobile terminal information and allows the communication between said mobile terminal and said digital door-lock, and a location server that obtains the location information of said mobile terminal and connects the terminal with said network gateway.

### Advantageous Effect

According to the embodiment of the present invention having the above-described configuration, a high level of security is provided by the user authentication process using the iris recognition.

Also, the degradation of recognition performance due to the change in the biometric information can be prevented by obtaining the user iris pattern.

The user convenience is improved by receiving the biometric information from the mobile device and registering it into the security system.

Furthermore, the user convenience can be improved by allowing the user in the remote site far away from the home to identify the visitor's face and automatically open or close the home front door.

### BRIEF DESCRIPTION OF THE SEVERAL VIEWS OF THE DRAWINGS

FIG. 1 shows the security system according to an embodiment of the present invention.

FIGS. 2a and 2b show the configuration of the door-lock with the iris recognition module according to an embodiment of the present invention.

FIG. 3 illustrates the detailed configuration of the door-lock according to an embodiment of the present invention.

FIG. 4 illustrates the configuration example of the iris recognition module according to an embodiment of the present invention.

FIGS. 5a and 5b show the face photographing, camera and the slope control of the iris camera according to an embodiment of the present invention.

FIG. 6 is the flow chart of the security system according to an embodiment of the present invention.

FIG. 7 shows the operation process of the security system for the user authentication according to an embodiment of the present invention.

FIG. 8 is the flow chart of the authentication process according to an embodiment of the present invention.

FIGS. 9a to 9c show the example of photographing the face and iris of the user approaching the door-lock according to an embodiment of the present invention.

FIG. 10 shows the system configuration of door-lock according to an embodiment of the present invention.

FIG. 11 illustrates the system operation of door-lock according to an embodiment of the present invention.

### EXPLANATION OF REFERENCE NUMERALS FOR MAIN PARTS IN THE DRAWING

200 security system (door-lock)
250 iris recognition module
230 micro controller
290 communication module
270 password key input module
210 wake-up module.

### DETAILED DESCRIPTION OF THE INVENTION

Although the present invention has been described with reference to the preferred embodiment in the attached figures, it is to be understood that various equivalent modifications and variations of the embodiments can be made by a person having an ordinary skill in the art without departing from the spirit and scope of the present invention as recited in the claims. Also, the terminology in the present disclosure is used to describe the embodiments and does not limit the present invention. The singular form may mean the plurality in the paragraph unless it is specifically expressed. The terminologies, “comprises” or “comprising” mean at least one of elements, steps, motions and/or devices in addition to element, step, motion, and/or device referred.

The terminology, “module” is to be interpreted to include software, hardware and the combination of both. For example, software may be machine language, firmware, embedded code and application software. For another example, hardware may be circuit, processor, computer, integrated circuit, integrated circuit core, sensor, MEMS (Micro-Electro-Mechanical System), passive device or the combination of them.

The terminology used in the present disclosure will be briefly explained, but its meaning will not limit the scope of the present invention unless it is specified in the present invention.

Servo-Control

Servo control is a kind of feedback control in which the controlled variable follows the target value. In the present invention, the iris pattern is obtained by the servo control in which the slope and motion of the iris camera with tilt mechanism are controlled after the eye position is sensed from the face picture of the user approaching the door-lock. Then, the user is authenticated by comparing the iris pattern with the pre-registered one.

Hereinafter, the present invention according to the preferred embodiments will be described in detail with reference to the drawings.

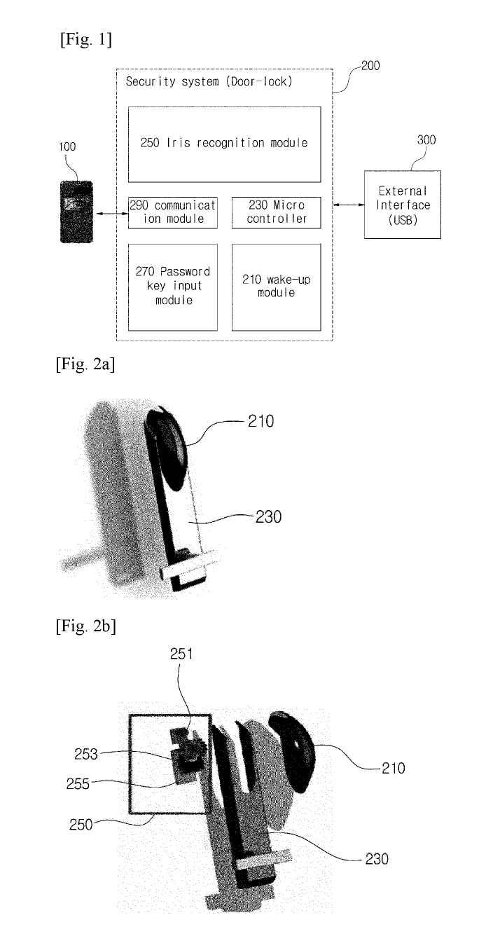

FIG. 1 shows the security system according to an embodiment of the present invention. Referring to FIG. 1, the security system according to an embodiment of the present invention comprises a mobile device (100), a door-lock (200) and an external device (300).

The mobile device (100) obtains the biometric information including the iris picture of the user. For example, the mobile device (100) obtains the biometric information including the iris pattern information by photographing the user's eye through the camera. The obtained biometric information is data processed and sent to the door-lock (200). The mobile device (110) is the portable gadget of the individual user, but not limited to the portable device. For example, the portable device may be the hand phone or mobile computer having the functions of communication, photographing and sensing.

The door-lock (200) stores the biometric information received from the mobile device (100). The user authentication is done by comparing the biometric information inputted from the user with the stored biometric information. The door-lock according to an embodiment includes a wake-up module (210), a micro controller (230), an iris recognition module (250), a password key input module (270) and a communication module (290).

The wake-up module (210) recognizes the user approach through the sensor, generates the wake-up signal by the button input, and thus drives the door-lock (200). The generated wake-up signal is input to the iris recognition module (250) through the micro controller (230).

Once the door-lock is driven, the iris recognition module (250) authenticates the user by comparing the iris pattern inputted to the door-lock with the pre-stored iris pattern.

The iris recognition of the present invention is used for authentication of the user approaching the door-lock, which is different from the user authentication using the password key described hereinafter. The authentication process using password key does not go thru the iris recognition process. The password key input module (290) receives the password key from the user for the authentication which is done by comparing the inputted password key with the pre-registered password key.

The communication module (290) supports the near field communication functions such as Bluetooth, IrDA (Infrared Data Association), RFID (Radio Frequency Identification), Zigbee, and NFC (Near Field Communication). According to an embodiment, the communication module (290) receives the user biometric information from the mobile device (100) or sends the user authentication information of the door-lock (200) to the mobile device (100) in real time.

The external device (300) stores the user biometric information that is registered in the door-lock (200) and sends the data to the door-lock (200). The external device (300) may consist of at least of one of non-volatile memories and volatile memories including ROM (Read Only Memory), Flash memory, RAM (Random Access Memory), HDD (Hard Disk) or other storing medium (e.g. USB).

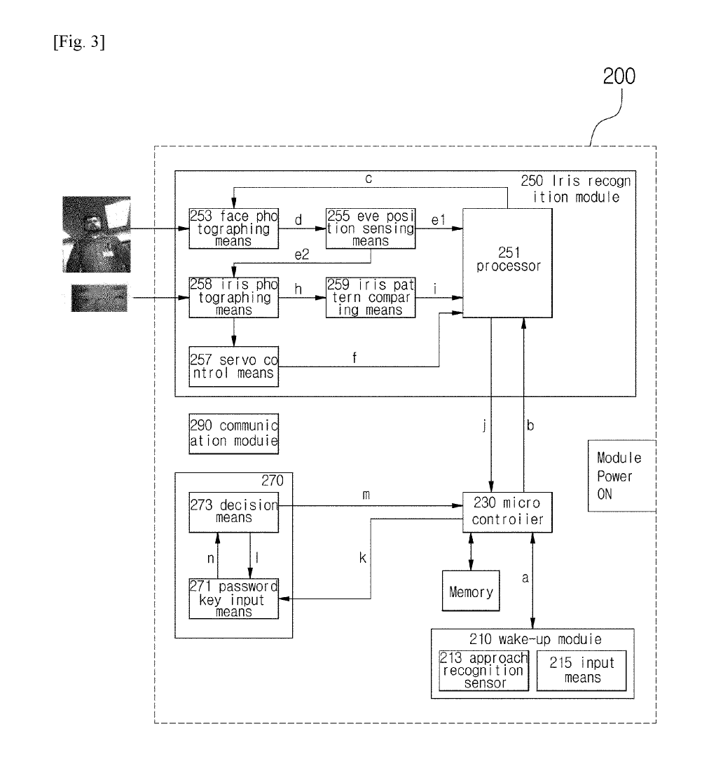

FIGS. 2a and 2b show the configuration of the door-lock with the iris recognition module according to an embodiment of the present invention. According to an embodiment, the door-lock having the iris recognition module comprises an optical window (210), an input key pad (230), and an iris recognition module (not shown).

Referring to FIG. 2b, the iris recognition module (250) consists of a face photographing camera (251), an iris camera (253) and a processor board (255).

The face photographing camera (251) photographs the face of the user approaching the door-lock. As the eye position is sensed from the photographed face picture, the iris camera (253) photographs the iris based on the eye position and takes the iris picture. At this time, the slope and motion of the iris camera (253) are controlled by the servo control with tilt mechanism applied. Afterwards, the processor board (255) extracts the iris pattern from the iris picture, compares the same with the pre-stored iris pattern, and thus performs the authentication based on the comparison result.

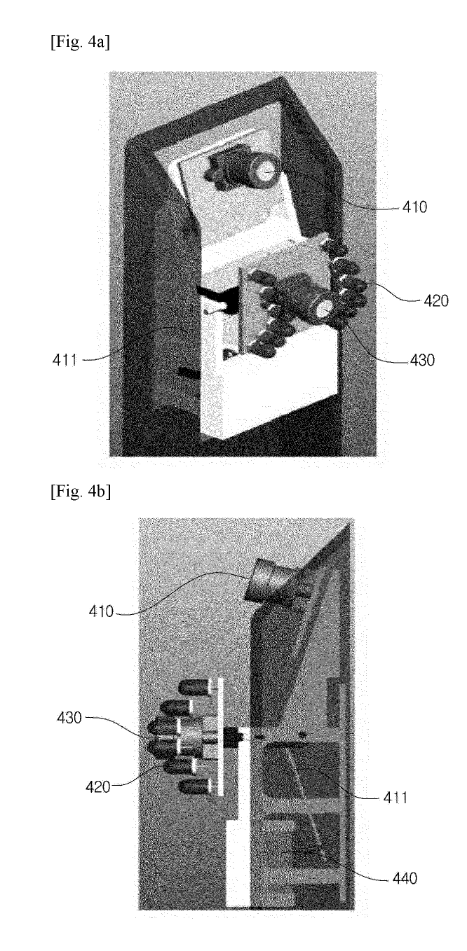

Hereinafter, the operation process of the door-lock will be described in detail with reference to FIG. 3.

FIG. 3 illustrates the detailed configuration of the door-lock according to an embodiment of the present invention. Referring to FIG. 3, the door-lock according to an embodiment includes the wake-up module (210) and the iris recognition module (250) which consists of processor (251), face photographing means (253), eye position sensing means (255), servo control means (257), iris photographing means (258) and iris pattern comparison means (259).

The wake-up module (210) senses the body approaching the door-lock (200) and inputs the sensed information (a) to the micro controller (230). For instance, the wake-up module (210) recognizes the body approaching the door-lock by the approach recognition sensor (213) and obtains the input signal from the user thru the input means (215), and generates the wake-up signal in order to drive the door-lock. The generated wake-up signal (a) is inputted to the micro controller (230).

The micro controller (230) obtains the right input from the user based on the wake-up signal (a) or, when the body is detected to be approaching the door-lock, transmits the photographing start signal (b) to the processor (251) of the iris recognition module (250).

The processor (251) of the iris recognition module (250) inputs the face photographing signal (c) to the face photographing means (253) according to the inputted photographing start signal (b). Then, the face photographing means (253) photographs the user face approaching near the door-lock (200). For instance, the face photographing means (253) may be the device such as camera, CMOS and DMOS.

After the user face is photographed, the face image data (d) is transmitted to the eye position sensing means (255) which senses the eye position through the general image process including edge detection from the face image data (d). For instance, the eye position sensing means (255) senses the coordinates of the left eye and right eye (e1, e2) and sends the coordinates to the iris photographing means (258) and the processor (251). The processor (251) identifies the eye position based on the coordinate information (e1), generates the iris photographing control signal (f), and sends the signal to the servo control means (257). The iris photographing control signal (f) may include the slope control signal of the iris camera according to the eye position and the iris camera actuating signal.

The servo control means (257) generates the photographing signal (g) based on the inputted iris photographing control signal (f) and sends the signal (g) to the iris photographing means (258).

According to the inputted photographing signal (g), the iris photographing means (258) photographs the user iris based on the eye coordinate information (e2). Once the user iris picture is taken, the user characteristic biometric information such as iris pattern is extracted from said iris picture. Then, the iris photographing means (258) sends the extracted information (h) to the iris comparing means (259).

The iris comparing means (259) compares the characteristic biometric information (h) including the iris pattern with the stored information. The comparison result (i) is inputted to the processor (251).

The processor (251) determines the authentication based on the comparison result (i). If the inputted biometric information corresponds to the stored information, the processor (251) ends the user authentication.

According another embodiment of the present invention, the authentication can be made for the user approaching the door-lock only by the password input. The present invention performs the user authentication thru the iris recognition and the iris pattern comparison. The user authentication thru password input described hereinafter is performed independently of the authentication thru the iris recognition.

The micro controller (230) transmits the inputted authentication process signal (k) to the password input means (271) of the password key input module (270).

Based on the authentication process signal (k), the password input means (271) receives the pre-determined password key such as ten key and pattern from the user. The inputted password key information (n) is transmitted to the decision means (273).

The decision means (273) authenticates the user by comparing the password key inputted by the user with the pre-determined password key. For instance, if the password key inputted corresponds to the stored password key, the door open signal and the authentication completion signal (m) are transmitted to the micro controller (230) and thus the door open is performed. On the other hand, if the password key inputted is different from the stored password key, the re-input signal is transmitted to the password input means (271) so that the user enters the password key again.

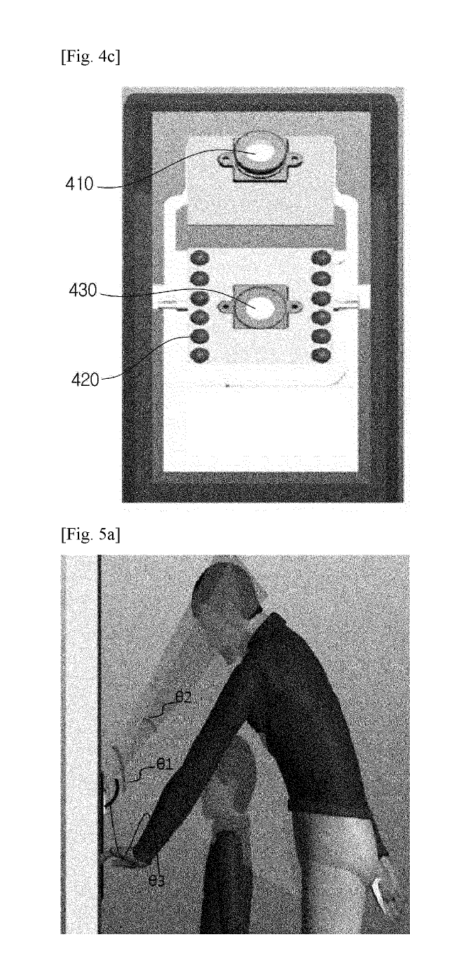

FIG. 4 illustrates the configuration example of the iris recognition module according to an embodiment of the present invention. According to an embodiment of the present invention, FIGS. 4a and 4c are the front view and the side view of the door-lock with the iris recognition module, respectively.

Referring to FIGS. 4a and 4c, the face photographing means (253) corresponds to the fixed camera (410), the iris photographing means (258) to the iris camera (430) with tilt mechanism applied, and the servo control means (257) to the servo motor (440), respectively.

In addition, the approach recognition sensor (113) of the wake-up module (110) corresponds to at least one of sensors (420) shown in FIGS. 4a and 4c.

More specifically, if the approach recognition sensor (420) senses the user approaching the door-lock, the face photographing camera (410) photographs the user face. Then, the eye position is sensed from the face picture.

After eye sensing, the user iris is photographed as the slope of iris camera with tilt mechanism is controlled by the axis (441) connected to the servo motor (440) and the angle of the iris camera (430) is adjusted to the slope.

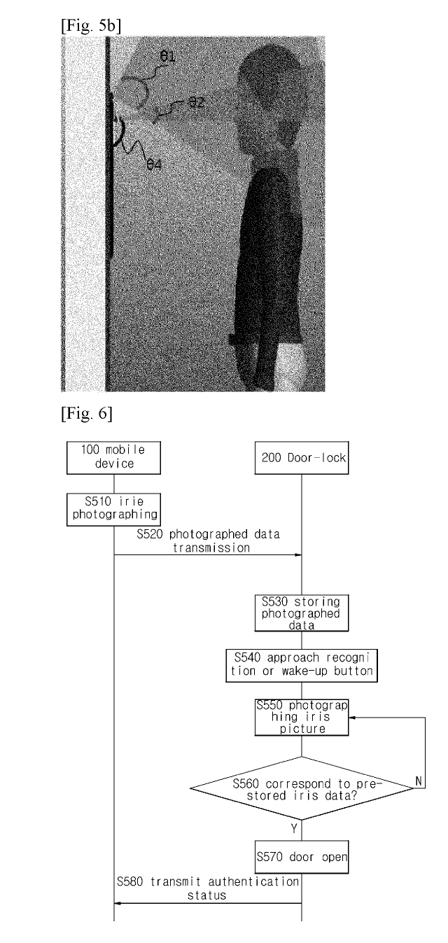

FIGS. 5a and 5b show the face photographing camera and the slope control of the iris camera according to an embodiment of the present invention.

Referring to FIGS. 5a and 5b, the face photographing camera (410) activated by the approach sensing photographs the user face within the angle, θ1. Then, when the eye position is sensed from the face picture, the slope of the iris camera is adjusted by the servo control and the user iris is photographed within the angle θ2.

The iris camera according to an embodiment adjusts its slope depending on the eye position to be photographed. For instance, as shown in FIG. 5a, if the user is tall, the servo control means (257) adjusts the slope of iris camera upwards to θ3 as the eye position of user is relatively high. On the other hand, if the user is short, the servo control means (257) adjusts the slope of iris camera downwards to θ4 as the eye position of user is relatively low.

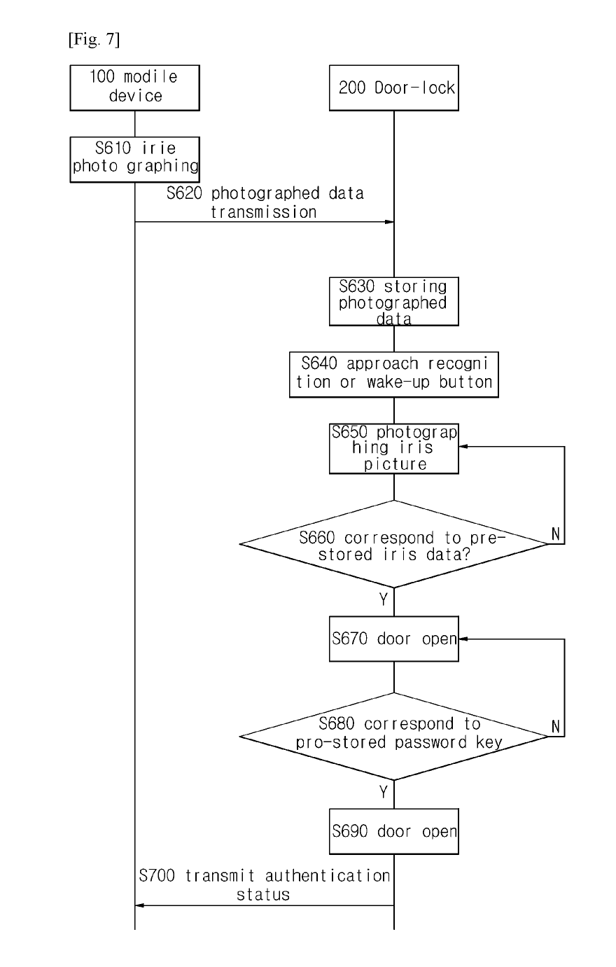

FIG. 6 is the flow chart of the security system according to an embodiment of the present invention. In S510 step, the mobile device (100) photographs the user biometric information including the iris. The mobile device (100) may be any of tablet PC, Laptop, Personal computer, Smart Phone, PDA (Personal Digital Assistant) and Mobile communication terminal. That is, the mobile device means the device having the memory for storing the specific application to make access to the door-lock (200) via the communication network (140) and the microprocessor for performing and controlling the program. Although the mobile device (100) is generally PC, it can be any terminal as long as it allows the server-client communication with the management server and broadly includes notebook computer, mobile terminal, PDA, and any computing device.

In S520 step, the data photographed in the mobile device (100) is transmitted to the door-lock (200). In S530, the data transmitted is stored in the door-lock (200). In S540, if the door-lock detects the body approaching or receives the button input from the user, the door-lock is driven. In S550, when the door-lock is driven, the iris picture is taken in the door-lock. In S560, the comparison is performed between the obtained iris picture and the stored iris picture. If the obtained iris picture corresponds to the stored iris picture, the door-lock ends the initial authentication and opens the door (S570). On the contrary, if the obtained iris picture is different from the stored iris picture, the process goes back to S550 and obtains the iris picture again. In S580, depending on the user option, the authentication status is transmitted to the mobile device (100) from the door-lock (200).

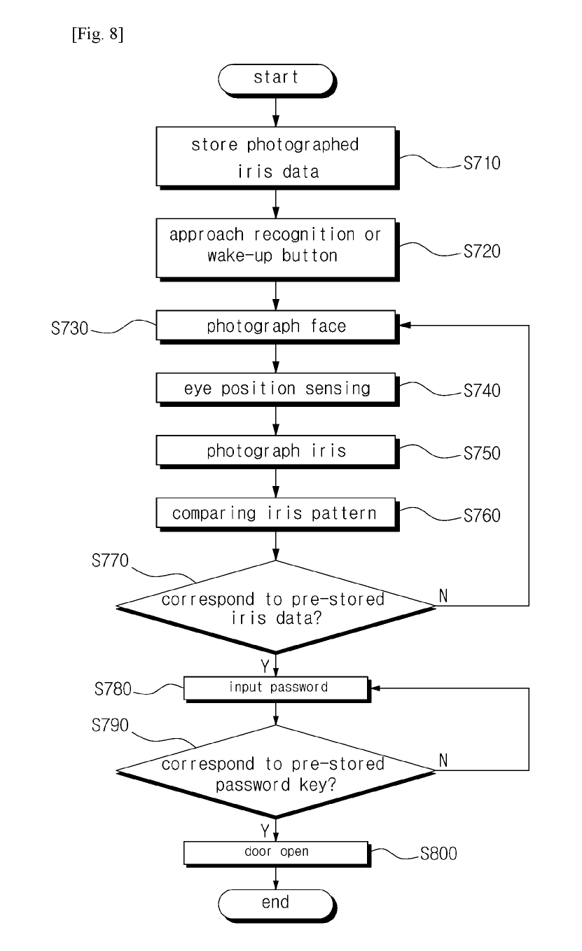

FIG. 7 shows the operation process of the security system for the additional user authentication according to an embodiment of the present invention.

The steps S610 to S660 correspond to S510 to S560 in FIG. 6. In S670, the door-lock (200) receives the password key inputted by the user.

In S680, the password inputted is compared with the pre-registered password key. If the password inputted corresponds to the pre-registered password key, the door-lock ends the additional authentication and opens the door (S690). If the password inputted is different from the pre-registered password key, the process goes back to S670 and repeats the password key input. In S700, depending on the user option, the authentication status is transmitted to the mobile device (100) from the door-lock (200).

Although it has been described in an embodiment that the additional authentication is done by the password key, the additional authentication could be any type such as pattern recognition, voice recognition, etc. to improve the security after the iris recognition.

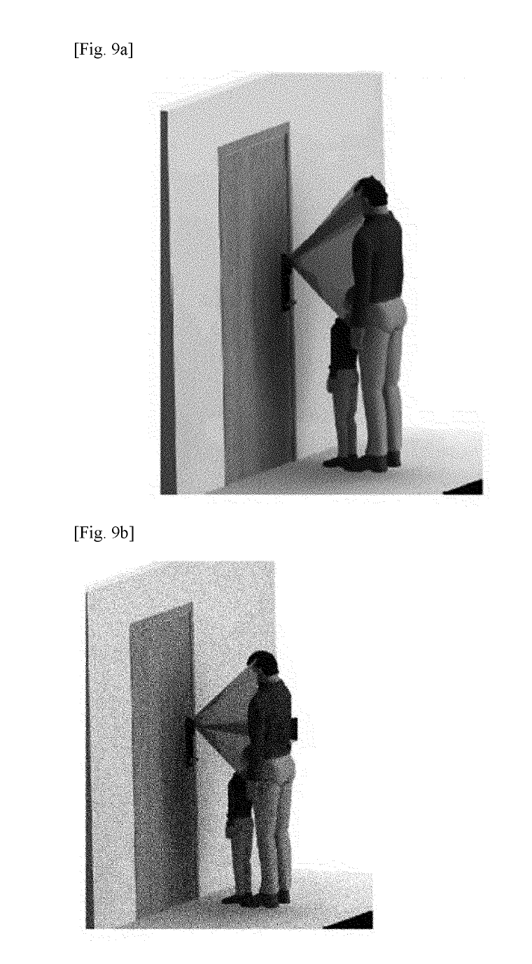

FIG. 8 is the flow chart of the authentication process according to an embodiment of the present invention.

In S710, the door-lock (200) stores the iris data received from the mobile device (100) or stores the iris data registered in the door-lock (200). In S720, the door-lock is driven by detecting the user approach by the wake-up module (110) or by the user input. In S730, the face photographing means (253) photographs the user's face approaching. In S740, the eye position sensing means (255) sense the eye position within the face area photographed. In S750, the iris photographing means (258) receives the eye position information and photographs the iris using the iris camera with slope adjusted depending on said eye position.

In S760, the iris comparing means (259) compares the iris pattern extracted from the photographed iris picture with the stored iris pattern. In S770, if the iris pattern extracted from the photographed iris picture corresponds to the stored iris pattern, the process proceeds to the step of additional authentication in which the processor (251) of the iris recognition module (250) receives the password key. If the iris pattern extracted from the photographed iris picture is different from the stored iris pattern, the process goes back to S730.

In S780, since the iris pattern extracted from the photographed iris picture corresponds to the stored iris pattern, the password input module (270) receives the password key from the user. In S790, the decision module (273) of the password input module (270) compares the pre-registered password key with the inputted password key.

If the pre-registered password key corresponds to the inputted password key, the additional authentication is completed and the micro controller (220) of the door-lock opens the door. (S800)

Although it has been described in an embodiment that the initial authentication is made by the iris recognition and the additional authentication by the password key, at least one of the initial authentication and the additional authentication can be applied depending on the user option. In addition, not only the iris pattern, but the characteristic information of iris color, finger print, and voice, etc. can be used.

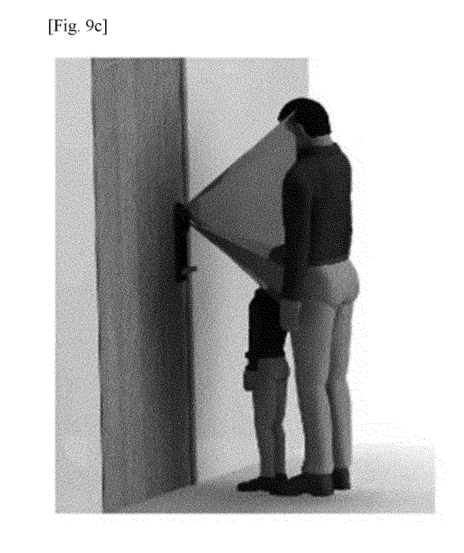

FIGS. 9a to 9c show the example of photographing the face and iris of the user approaching the door-lock according to an embodiment of the present invention.

Referring to FIG. 9a, as the relatively tall user approaches the door-lock and is sensed, the slope of the iris camera is automatically adjusted according to the eye position sensed. After the slope is adjusted, the iris picture of the user is obtained and the authentication is processed.

FIG. 9b shows the embodiment obtaining the user iris picture without slanting the iris camera. FIG. 9c shows the embodiment obtaining the user iris picture when the short user approaches the door-lock.

Referring to FIG. 9c, for instance, when the short user like child approaches the door-lock and is sensed, the face is photographed by the face camera, and as the eye position is sensed, the slope of the iris camera is automatically adjusted depending on the eye position. After adjustment, the iris pattern is obtained and the authentication process is performed.

In the present invention, the initial authentication is done by sensing the eye position from the user face picture, obtaining the iris picture and comparing the iris pattern. After initial authentication, the additional authentication is processed by the password key input, and thus the high level of security is provided.

Moreover, as the iris image information is obtained by the iris camera with the slope automatically adjusted, the degradation of recognition due to the change in biometric information is prevented.

Also, the user convenience is improved as the user biometric information can be easily registered into the security system by providing the communication module with the door-lock to enable the communication with the mobile device.

The door-lock in the present invention can be applied for the systems requiring the security such as ATM, alarm device, safe box, front door, PC, etc.

In the above, the configuration of the present invention has been described in detail with reference to the drawings attached, but it is only the example and the various modifications are possible as long as the technical scope is not beyond the present invention. Accordingly, the scope of the present invention is not limited to the embodiments described and will be determined by not only the claims, but the equivalents of the claims.

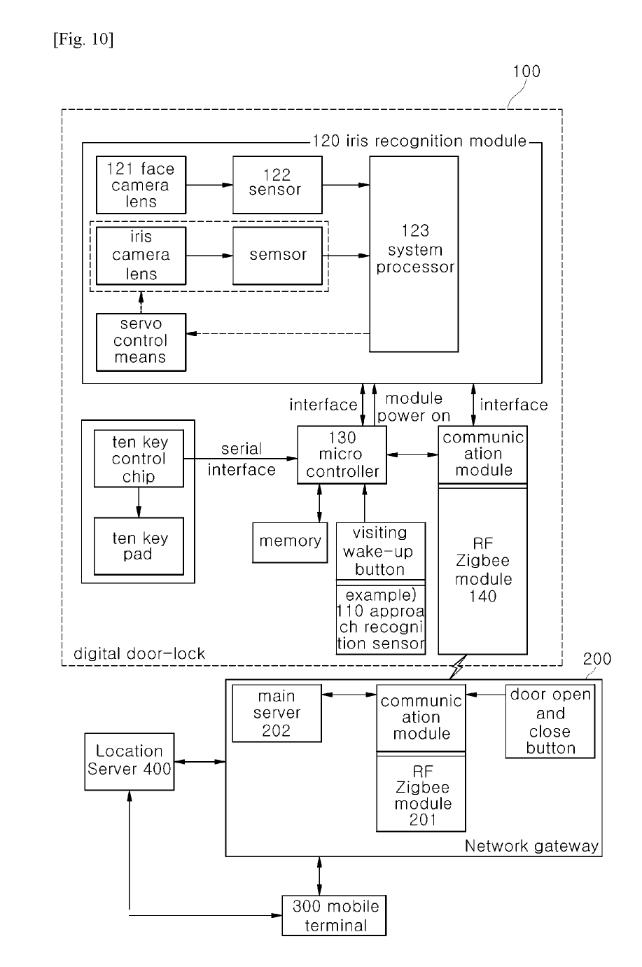

FIG. 10 shows the system configuration of mobile terminal digital door-lock for the face recognition according to the present invention.

As shown in FIG. 10, the digital door-lock system according to the present invention comprises a digital door-lock (100), a mobile terminal (300), a network gateway (200) that registers the mobile terminal information and allows the communication between said mobile terminal and said digital door-lock, and a location server (400) that obtains the location information of said mobile terminal and connects the terminal with said network gateway.

The digital door-lock (100) obtains the visitor face picture approaching the door-lock, processes the picture (editing+compression), transmits the data to the network gateway (200), and controls the door open in response to the door open signal of the mobile terminal (300), which is transmitted via the network gateway (200).

The configuration comprises a wake-up button (110) for driving said door-lock by the button input of the visitor; an approach recognition sensor for recognizing the visitor's approach; an iris recognition module (120) having a system processor (123) for comparing the iris pattern of the user approaching said door-lock with the stored iris pattern and authenticating the user depending on the comparison result; and a micro controller (130) for controlling the door open and close based on the authentication of said user. Said configuration further comprises a face camera lens (121) for taking the face picture of the visitor approaching said door-lock and a face picture taking means having the sensor (122) for sensing the picture of said face camera lens (121), wherein the face camera lens (121) is connected electrically to the system processor (123) of said iris recognition module (120) and the system processor (123) of said iris recognition module (120) has the functions of editing and compressing the picture sensed by said sensor (122). Said microcontroller (130) initiates said iris recognition module (120) when said wake-up button is inputted or said approach recognition sensor senses the visitor's approach. The visitor's face is data compressed by said iris recognition module (120) and transmitted to the network gateway (200) that registers the mobile terminal information and allows the communication between said mobile terminal (300) and said digital door-lock (100). The door open and close is controlled in response to the control signal of the said mobile terminal (300), which is transmitted from the said network gateway (200). And said configuration further comprises the communication module (RF (Zigbee) module) for transmitting the visitor's face image compressed by the system processor (123) of said iris recognition module (120) to said network gateway (200).

The network gateway (200) registers the information of the mobile terminal that will transmit the visitor's face picture approaching the digital lock (100), and allows the communication between said mobile terminal and said digital door-lock. Said network gateway (200) delivers the visitor's face picture that the digital lock (100) has taken to the mobile terminal (300) based on the location information of the mobile terminal, and delivers in the other way the door open control signal from the mobile terminal to said digital door-lock (100). The configuration comprises a communication module (201) for transmitting the visitor face picture from the digital door-lock (100); and a main processor (202) for controlling the overall network interfaces of the network gateway (200), wherein said main processor registers the information of the mobile terminal (300) and the location information of the mobile terminal is updated by said location server (400) so that the connection with the mobile terminal is ensured. The wireline or wireless internet access points are also configured. Under such configuration, said network gateway (200) delivers the visitor's face picture that the digital lock (100) has taken to the mobile terminal (300) based on the location information of the mobile terminal, and delivers in the other way the door open control signal from the mobile terminal to said digital door-lock (100). Said network gateway (200) further comprises the door open and close button (203) that is electrically connected to said communication module (201).

The mobile terminal (300) is such that the terminal information is registered in the network gateway (200). (e.g. the smart phone installed in the door-lock (100) with the phone information registered in the network gateway (200)) Said mobile terminal (300) displays the visitor face picture by the push alarm which has been received from said network gateway (200), and transmits the door open signal for said digital door-lock to said network gateway (200). Said mobile terminal (300) comprises a storage means for storing the application program to authenticate the visitor's face, and a control means for driving said application program, wherein said control means displays the visitor face picture using said application program and transmits the door open signal to said network gateway in response to the user input information. When said user inputs the door open command, said control means transmits the door open signal and password to the digital door-lock via said network gateway (200). The door-lock performs the door open command only when the password is identical to the pre-registered password. (Since the pre-registered password is held only by the door-lock, its leakage due to gateway hacking, etc. can be prevented.)

The location server (400) gathers the location information of the network gateway and said mobile terminal so that both network elements are configured in the network. The location information gathered of said mobile terminal is reported to the network gateway (200), and the location information of the network gateway is informed to the mobile terminal (300). For example, said location information is Wi-Fi IP address when the mobile terminal is connected by Wi-Fi, and is the hand phone number when the mobile terminal is not connected by Wi-Fi. Said location server (400) receives the changed location information (e.g. IP address) whenever the location of the network gateway is changed and thus allows the networking with the mobile terminal (300).

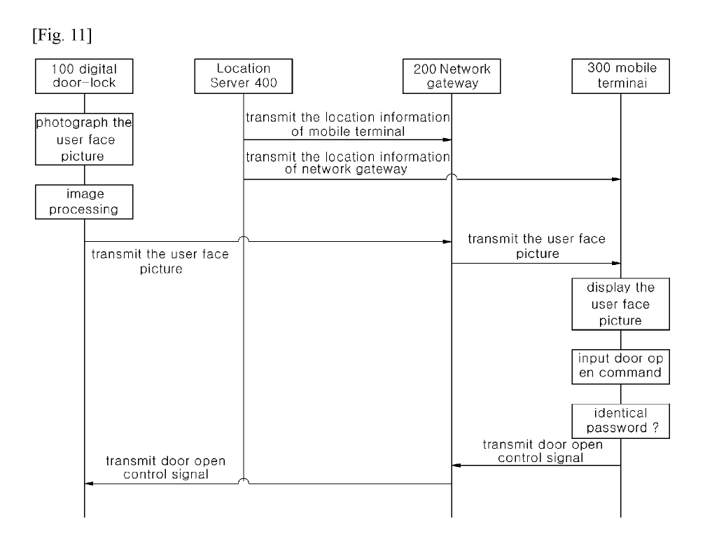

FIG. 11 illustrates the system operation of door-lock for face recognition according to an embodiment of the present invention.

As shown in FIG. 11, the digital door-lock system according to the present invention starts with obtaining the face image of the visitor approaching the digital door-lock and then sends the image data processed to the network gateway. That is, the visitor face image is obtained by the face camera lens and the image sensor of the same. Then, the face image is edited and compressed. The face image is edited with free space added around the face and then said edited image is compressed for transmission. Thus, the compressed image is transmitted to the network gateway.

The network gateway registers the information of the mobile terminal to which the visitor face image is transmitted and configures the networking between the said mobile terminal and said digital door-lock. Then, said network gateway transmits the face image to the mobile terminal based on the information received from the location server.

Said mobile terminal displays the visitor face picture by the push alarm which has been received from said network gateway, and transmits the door open signal for said digital door-lock to said network gateway after the user identifies the visitor face.

For example, said mobile terminal transmits the door open signal and password to the network gateway when the input information is the door open command from the application program (visitor face identification program). The network gateway delivers the door open command and password to the digital door-lock. The door-lock performs the door open command only when the password is identical to the pre-registered password. (The pre-registered password is held only by the door-lock and the password leakage is prevented.)

Said network gateway sends the door open control signal received from said mobile terminal to said digital door-lock through RF (or Zigbee) communication.

The digital door-lock controls the door in response to the door open signal of said mobile terminal and allows or denies the visitor to pass through.

### INDUSTRIAL APPLICABILITY

The present invention can be applied for the door-lock requiring the enhanced security. Furthermore, it can be applied for the various security systems such as alarm system, safe box, front door, PC and ATM, etc.

1. A door-lock, comprising;
a wake-up module for driving said door-lock based on the user button input, and
an iris recognition module for authenticating the user approaching said door-lock by comparing an iris pattern with a pre-stored iris pattern after said door-lock is driven by said wake-up module.

2. The door-lock of claim 1, wherein said iris recognition module comprises,
a face photographing device for taking the face picture of the user approaching said door-lock after said door-lock is driven;
an eye position sensing means for sensing the eye position of the user from the user face picture taken by said face photographing means;
a servo control means for controlling the slope of an iris photographing means based on said sensing result of the eye position, and generating the control signal for the iris photographing;
an iris photographing means for taking the iris of the user approaching said door-lock based on said control signal for the iris photographing; and
a comparing means for comparing said photographed iris pattern with the pre-stored iris pattern, and
based on said comparison result, the user approaching said door-lock is authenticated.

3. The door-lock of claim 2, wherein said iris photographing means has a tilt mechanism controlled by said control signal for the iris photographing generated from said servo control means, and is slanted depending on said sensed eye position.

4. The door-lock of claim 1, wherein said wake-up module comprises,
at least one of approach recognition sensors for sensing the body approaching the door-lock; and an input means for taking the use's button input, and
based on said sensing result and the input signal, the door-lock is driven.

5.-6. (canceled)

7. An user authentication method, comprising;
a step of sensing the user approach;
a step of taking said user's face picture based on said sensing result when the door-lock is driven;
a step of sensing the eye position from said user's face picture;
a step of taking an iris picture of said user based on said sensed eye position by adjusting the slope of the iris camera; and
a step of comparing the iris pattern extracted from said iris picture with the pre-stored iris pattern and authenticating said user based on the comparison result.

8. The user authentication method of claim 7, wherein the step of taking the iris picture of said user is accomplished by controlling the slope or motion of the iris camera by the servo control.

9. The user authentication method of claim 8, wherein the step of taking the iris picture of the user further comprises,
a step of taking the iris picture by the iris camera; and
a step of extracting the iris pattern from said iris picture.

10. The user authentication method of claim 7, wherein said pre-stored iris pattern is either the data base of the iris pattern extracted from the iris picture received from the mobile device having the communication function, or the data base of the iris pattern extracted from the iris picture photographed by the door-lock.

11. A digital door-lock system using the iris recognition, comprising;
a digital door-lock;
a network gateway that registers the information of the mobile terminal to transmit the face picture of the visitor approaching said digital door-lock, and allows the networking between said mobile terminal and said digital door-lock;
a mobile terminal for which said network gateway has terminal information registered; and
a location server that gathers the location information of said mobile terminal and said network gateway and allow the interconnection between said mobile terminal with said network gateway;
wherein said digital door-lock takes the face picture of the visitor approaching, processes the image data, and transmits the data to the network gateway,
wherein said network gateway transmits the visitor's face picture obtained from said digital door-lock to said mobile terminal based on the location information received from said location server,
wherein said mobile terminal displays by push alarm the visitor's face picture transmitted from said network gateway and returns the door open control signal for said digital door-lock to said network gateway based on the location information received from said location server,
wherein said network gateway delivers said door open signal to said digital door-lock,
wherein said digital door-lock controls the door open in response to said door open signal of said mobile terminal.

12. The digital door-lock system using the iris recognition of claim 11, wherein said digital door-lock comprises,
a wake-up button for driving said door-lock based on the visitor's input;
an iris recognition module having the system processor for authenticating the user approaching said door-lock by comparing an iris pattern of the user approaching said door-lock with the pre-stored iris pattern;
a microcontroller for controlling the door open and close based on said authentication result; and
a face photographing means which is electrically connected to the system processor of said iris recognition module, and has a face camera lens for photographing the visitor's face approaching said door-lock and a sensor for sensing the photograph of said face camera lens,
wherein said system processor of said iris recognition module has the functions of editing and compressing the image sensed by said sensor;
said microcontroller controls the start of said iris recognition module upon the button input of said wake-up button, transmits the visitor face image compressed by said iris recognition module to the network gateway networking with said digital door-lock and the pre-registered mobile terminal, and controls the door open and close in response to the door open control signal of said mobile terminal; and
a communication module is further comprised for transmitting the visitor face image to said network gateway.

13. The digital door-lock system using the iris recognition of claim 11, wherein said digital door-lock comprises,
an approach recognition sensor for recognizing the visitor's approach;
the iris recognition module having the system processor for authenticating the user approaching said door-lock by comparing an iris pattern of the user approaching said door-lock with the pre-stored iris pattern;
the microcontroller for controlling the door open and close based on said authentication result; and
the face photographing means which is electrically connected to the system processor of said iris recognition module, and has a face camera lens for photographing the visitor's face approaching said door-lock and a sensor for sensing the photograph of said face camera lens,
wherein said system processor of said iris recognition module has the functions of editing and compressing the image sensed by said sensor;
said microcontroller controls the start of said iris recognition module upon the button input of said wake-up button, transmits the visitor face image compressed by said iris recognition module to the network gateway networking with said digital door-lock and the pre-registered mobile terminal, and controls the door open and close in response to the door open control signal of said mobile terminal; and
the communication module is further comprised for transmitting the visitor face image to said network gateway.

14. The digital door-lock system using the iris recognition of claim 11, wherein said network gate way comprises,
the communication module for transmitting the visitor face image from said digital door-lock; and
a main processor for controlling the overall interfaces of said network gateway,
wherein said main processor registers the information of the mobile terminal and the location information of the mobile terminal is updated by said location server so that the connection with the mobile terminal is ensured;
the wireline or wireless internet access points are also configured; and
said network gateway delivers the visitor's face picture that said digital lock has taken to the mobile terminal based on the location information of the mobile terminal, and delivers in the other way the door open control signal from the mobile terminal to said digital door-lock.

15. The digital door-lock system using the iris recognition of claim 14, wherein said network gateway further comprises,
a door open and close button which has the interlocking function with door-lock electrically connected to said communication module.

16. A digital door-lock system using the iris recognition of claim 11, wherein the mobile terminal comprises;
a storage means for storing the application program to authenticate the visitor's face; and
a control means for driving said application program,
wherein said control means displays the visitor face picture using said application program and transmits the door open signal to said network gateway in response to the user input information.

17. The digital door-lock system using the iris recognition of claim 16, wherein,
when said user inputs the door open command, said control means transmits the door open signal and password to said digital door-lock via said network gateway, and the door-lock performs the door open command only when the password is identical to the pre-registered password.

18.-23. (canceled)

24. The digital door-lock system using iris recognition of claim 12, wherein said network gate way comprises,
the communication module for transmitting the visitor face image from said digital door-lock; and
a main processor for controlling the overall interfaces of said network gateway,
wherein said main processor registers the information of the mobile terminal and the location information of the mobile terminal is updated by said location server so that the connection with the mobile terminal is ensured;
the wireless or wireless internet access points are also configured; and
said network gateway delivers the visitor's face picture that said digital lock has taken to the mobile terminal based on the location information of the mobile terminal, and delivers in the other way the door open control signal from the mobile terminal to said digital door-lock.

25. The digital door-lock system using the iris recognition of claim 24, wherein said network gateway further comprises,
a door open and close button which has the interlocking function with the door-lock electrically connected to said communication module.

26. The digital door-lock system using the iris recognition of claim 13, wherein said network comprises,
the communication module for transmitting the visitor face image from said digital door-lock; and
a main processor for controlling the overall interfaces of said network gateway,
wherein said main processor registers the information of the mobile terminal and the location information of the mobile terminal is updated by said location server so that the connection with the mobile terminal is ensured;
the wireless or wireless internet access points are also configured; and
said network gateway delivers the visitor's face picture that said digital lock has taken to the mobile terminal based on the location information of the mobile terminal, and delivers in the other way the door open control signal from the mobile terminal to said digital door-lock.

27. The digital door-lock system using the iris recognition of claim 26,
wherein said network gateway further comprises a door open and close button which has the interlocking function with door-lock electrically connected to said communication module.
